(19) United States
(12) Patent Application Publication
(10) Pub. No.: US 2025/0165814 A1
(43) Pub. Date: May 22, 2025

(54) DOMAIN KNOWLEDGE UTILIZATION SYSTEM, DOMAIN KNOWLEDGE UTILIZATION METHOD, AND DOMAIN KNOWLEDGE UTILIZATION PROGRAM

(71) Applicant: HITACHI, LTD., Tokyo (JP)

(72) Inventors: Kazuki Horiwaki, Tokyo (JP); Kazuo Muto, Tokyo (JP)

(73) Assignee: HITACHI, LTD., Tokyo (JP)

(21) Appl. No.: 18/841,863

(22) PCT Filed: Sep. 8, 2022
(86) PCT No.: PCT/JP2022/033765

§ 371 Date: Aug. 27, 2024

(30) Foreign Application Priority Data
Mar. 1, 2022 (JP) 2022-030811

(51) Int. Cl. G06N 5/022

(52) U.S. Cl. CPC G06N 5/022

(57) ABSTRACT

In a domain knowledge utilization system in which a utilization algorithm for utilizing domain knowledge described by a graph for construction and training of a prediction model can be selected, a utilization algorithm that is selectable by an algorithm selection unit includes at least one or more of a first utilization algorithm using a feature derived from the graph as an explanatory variable of the prediction model, a second utilization algorithm applying a relationship between nodes in the graph to a relationship between explanatory variables of the prediction model, and a third utilization algorithm applying a definition of a node in the graph to a training condition of the prediction model.

### TECHNICAL FIELD

The present invention relates to a domain knowledge utilization system, a domain knowledge utilization method, and a domain knowledge utilization program.

### BACKGROUND ART

JP2004-334841A (PTL 1) discloses that information related to knowledge obtained from personal experience is input in a format such as an electronic questionnaire, and knowledge information in which knowledge and an experienced activity are associated is accumulated in a database.

JP2021-2126A (PTL 2) discloses that a user draws a graph structure expressing an item and an item value related to a product design, and trains a multidimensional model having a part of the item in the received graph structure as an explanatory variable.

### CITATION LIST

### Patent Literature

PTL 1: JP2004-334841A

PTL 2: JP2021-2126A

### SUMMARY OF INVENTION

### Technical Problem

In an industrial field, it is expected that machine learning is used for decision making in an important scene of a business. For this purpose, it is required that a prediction model can derive a more accurate prediction result, and a conclusion that can be derived from the prediction model matches knowledge unique to a field known in an industrial field in which machine learning is used.

In order to improve accuracy of the prediction model, it is generally necessary to train a prediction model with a large amount of training data having a high quality. However, in the industrial field, cost of acquiring training data that can be used for training of a prediction model is high, and an amount of training data is often limited.

In PTL 1, based on information accumulated in the database, a two-dimensional table of a total number of pieces of knowledge with activities and knowledge creation processes in columns and rows, a graph of propagation status of knowledge, and the like are displayed and output, and utilizing accumulated knowledge in a prediction model of machine learning or the like is not considered. Although information related to a specific data item is visible in the two-dimensional table or the graph of propagation, it is considered that it is difficult to make relevance and a constraint between data items apparent, and it is also difficult to determine whether information matches knowledge unique to a field known in the industrial field from the display.

In PTL 2, by setting an item of a graph structure drawn by a user as an explanatory variable and a response variable of a multidimensional model, less important variables can be eliminated, but it is considered that a large amount of training data is still required to improve prediction accuracy of the multidimensional model.

The invention provides a system, a method, and a program that reflect domain knowledge in machine learning by showing domain knowledge as a definition of a node or edge in a graph using an expression format that is a user-readable graph, transforming the domain knowledge described as a graph into a mathematical expression, and reflecting the transformed domain knowledge in data items, constraints on the data items, a relationship between the data items, and the like of a prediction model for performing machine learning.

### Solution to Problem

In order to solve the above problem, for example, a configuration described in the claims is adopted.

The present application includes a plurality of systems for solving the above problem, and an example thereof is a domain knowledge utilization system. The domain knowledge utilization system includes: a graph description unit configured to describe domain knowledge about a target system as a definition of a node or an edge in a graph including nodes and edges indicating a relationship between nodes; a model construction unit configured to perform construction and training of a prediction model for predicting a response variable based on an independent variable for the target system; and an algorithm selection unit configured to select a utilization algorithm for utilizing domain knowledge described by the graph for construction and training of the prediction model, in which a utilization algorithm that is selectable by the algorithm selection unit includes at least one or more of a first utilization algorithm using a feature derived from the graph as an independent variable of the prediction model, a second utilization algorithm applying a relationship between nodes in the graph to a relationship between independent variables of the prediction model, and a third utilization algorithm applying a definition of a node in the graph to a training condition of the prediction model.

### Advantageous Effects of Invention

Provided is a system capable of constructing a highly accurate prediction model by utilizing domain knowledge of a target system for machine learning even when less training data is obtained. Other problems, configurations, and effects will become apparent from the following description of embodiment.

### BRIEF DESCRIPTION OF DRAWINGS

FIG. 1 is a functional block diagram of a domain knowledge utilization system.

FIG. 2 is an example of a graph description screen.

FIG. 3 is an example of an algorithm selection screen.

FIG. 4 is an example of a model construction screen.

FIG. 5A is an example of a model result display screen.

FIG. 5B is an example of a model detail display screen.

FIG. 6 is an example of a model management screen.

FIG. 7 is a diagram showing an overall processing flow using domain knowledge in machine learning.

FIG. 8 is a diagram showing a graph transformation processing flow.

FIG. 9 is a diagram showing a selection processing flow of a utilization algorithm.

FIG. 10 is a diagram showing a preprocessing flow according to the utilization algorithm.

FIG. 11 is a diagram showing a construction and evaluation processing flow of a prediction model.

FIG. 12 is a data structure example of target data.

FIG. 13A is a data structure example of edge data.

FIG. 13B is a data structure example of edge label data.

FIG. 13C is a data structure example of edge weight data.

FIG. 13D is a data structure example of node data.

FIG. 13E is a data structure example of node constraint data.

FIG. 13F is a data structure example of block node data.

FIG. 14A is a data structure example of prediction model data.

FIG. 14B is a schematic diagram of a prediction model.

FIG. 15 is a data structure example of algorithm data in which details of a utilization algorithm are registered.

FIG. 16 is a data structure example of management data for managing a preprocessing result according to the utilization algorithm.

FIG. 17A is a data structure example of management data for managing a result of training and evaluating a prediction model.

FIG. 17B is a data structure example of a parameter file.

FIG. 17C is a data structure example of a training evaluation file.

FIG. 18 is a diagram showing graph data when interpreted as a mathematical expression format.

FIG. 19 is an example of a generative model using a variation autoencoder.

### DESCRIPTION OF EMBODIMENTS

Hereinafter, an embodiment of the invention will be described with reference to the drawings. In the drawings for showing the embodiment, the same parts are denoted by the same reference signs in principle, and the repeated description thereof is omitted.

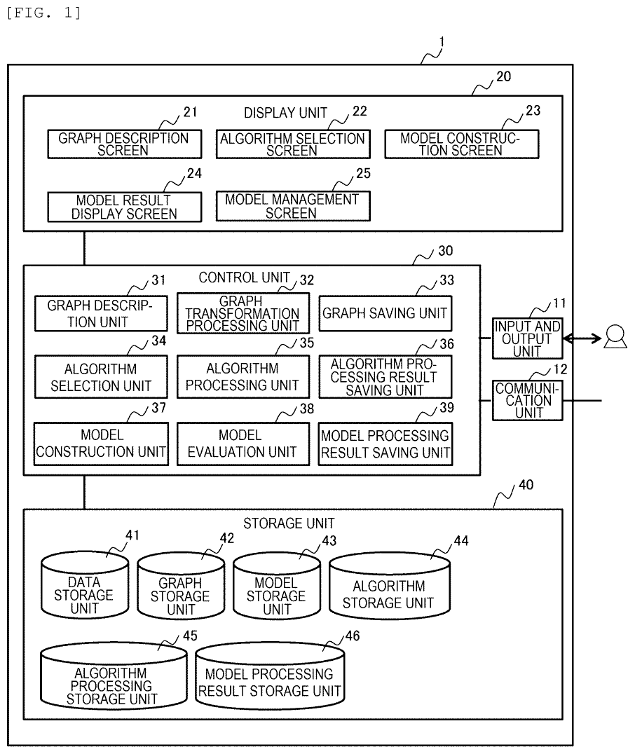

FIG. 1 is a functional block diagram showing a configuration example of a domain knowledge utilization system. A domain knowledge utilization system 1 can be implemented by a general information processing device (a computer such as a PC or a server), and implements characteristic processing of the present embodiment by executing a software program. Functions of the present system can be implemented not in a single computer but in a distributed system or cloud by a plurality of servers.

The domain knowledge utilization system 1 includes an input and output unit 11, a communication unit 12, a display unit 20, a control unit 30, and a storage unit 40.

The input and output unit 11 includes an output device such as a display for presenting information to a user, and an input device such as a keyboard, a mouse, or a pointing device for the user to input an instruction and information. It is possible to execute system processing interactively with a user via a graphical user interface (GUI) to be described later.

The communication unit 12 includes a communication interface device for a communication network external to the domain knowledge utilization system 1, and communicates with an external server, a manufacturing device, or the like. The communication unit 12 is used to acquire and refer to necessary data and the like from an external server, a storage, a device to be controlled, for the like in accordance with control from the control unit 30.

The display unit 20 displays various GUI screens on the output device of the input and output unit 11. The GUI screen used by the present system will be described later.

The control unit 30 implements each function by a processor (CPU) executing an instruction (program) called, for example, into a main memory such as a RAM. The control unit 30 includes a graph description unit 31, a graph transformation processing unit 32, a graph saving unit 33, an algorithm selection unit 34, an algorithm processing unit 35, an algorithm processing result saving unit 36, a model construction unit 37, a model evaluation unit 38, and a model processing result saving unit 39, and executes processing to implement a characteristic function of the present embodiment.

The storage unit 40 is stored in a nonvolatile memory such as an HDD, an SSD, or a flash memory, and stores data uploaded to the present system or data generated during processing of the present system. The storage unit 40 includes a data storage unit 41, a graph storage unit 42, a model storage unit 43, an algorithm storage unit 44, an algorithm processing storage unit 45, and a model processing result storage unit 46.

The domain knowledge utilization system 1 describes domain knowledge of a user as a graph, and uses the domain knowledge described as the graph for constructing and training a prediction model by machine learning.

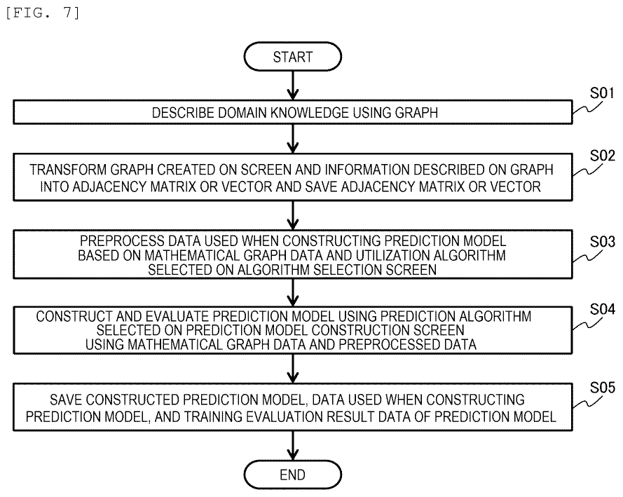

A processing flow utilizing domain knowledge for machine learning will be described with reference to FIG. 7.

Step S01: processing executed by the graph description unit 31 to describe domain knowledge as a definition of a node or an edge in a graph.

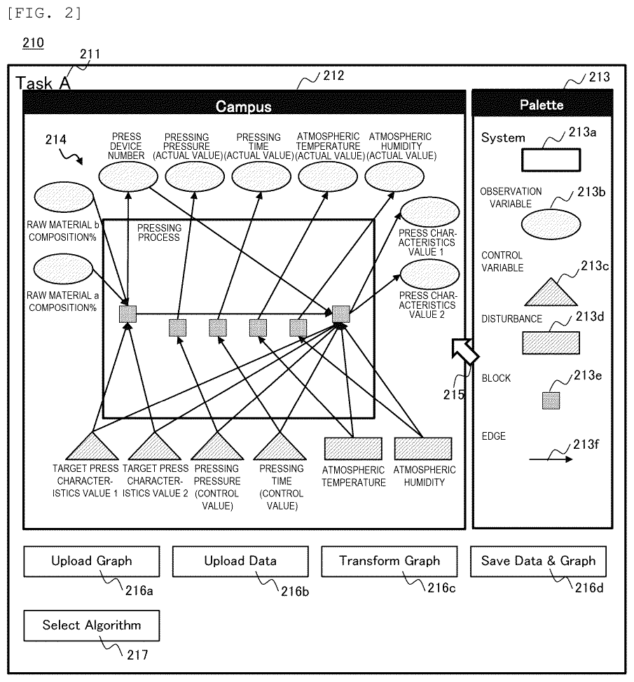

In the present step, the user describes his or her own domain knowledge in an expression format called a graph. FIG. 2 shows an example of a graph description screen 210 displayed as a page or a window by a graph description screen display unit 21. The graph description screen 210 displays a task ID 211 assigned to each problem to be solved by a machine learning model. For creation of the graph, a screen called campus 212 on which the user creates a graph, and a screen called a palette 213 on which graph parts used by the user to create a graph are displayed are mainly used.

First, the user creates a graph 214 on the campus 212 by combining parts selected from the palette 213. Parts arranged in the palette 213 are as follows. A system box 213a represents a target system to be solved by the machine learning model. An observation variable node 213b represents a data item observable from the target system. A control variable node 213c represents a data item used as a control item in the target system. A disturbance node 213d represents a disturbance in the target system. A block node 213e is a node that represents a relationship between nodes in the target system. An edge 213f is an arrow indicating a relationship between nodes. A simple descriptive text may be added to the palette 213 so that the user can easily understand contents and meanings of various nodes and edges.

The user selects a part using an icon 215 from the palette 213, moves the part onto the campus 212, and combines parts to create the graph 214 showing the domain knowledge. At this time, a name (label) or summary of each node can be displayed together with the corresponding node. Accordingly, it can be understood that the graph 214 shown in FIG. 2 relates to a metal pressing process. Instead of always creating the graph 214 from scratch, the user can press an upload graph button 216a to transition to a graph upload screen (not shown) and upload and reuse an already created graph.

Subsequently, the user adds information based on knowledge unique to a field owned by the user to the node or edge in the graph 214 created on the campus 212. For example, any node in the graph 214 is associated with a data item of uploaded data. Information such as distribution estimation and constraints on values that can be taken by the node of the graph 214, and attribute information on the edge of the graph 214 are set. The attribute information is information indicating a relationship between nodes connected by an edge, and a specific example will be described later. Information that the user can add to the graph 214 as the domain knowledge is diversified, and is not limited to the information shown in the present embodiment.

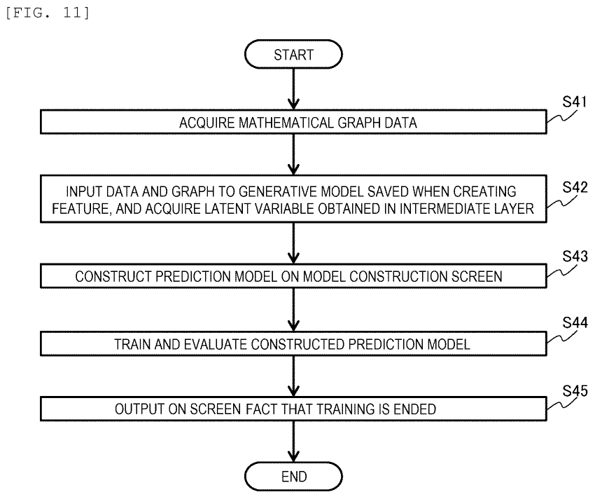

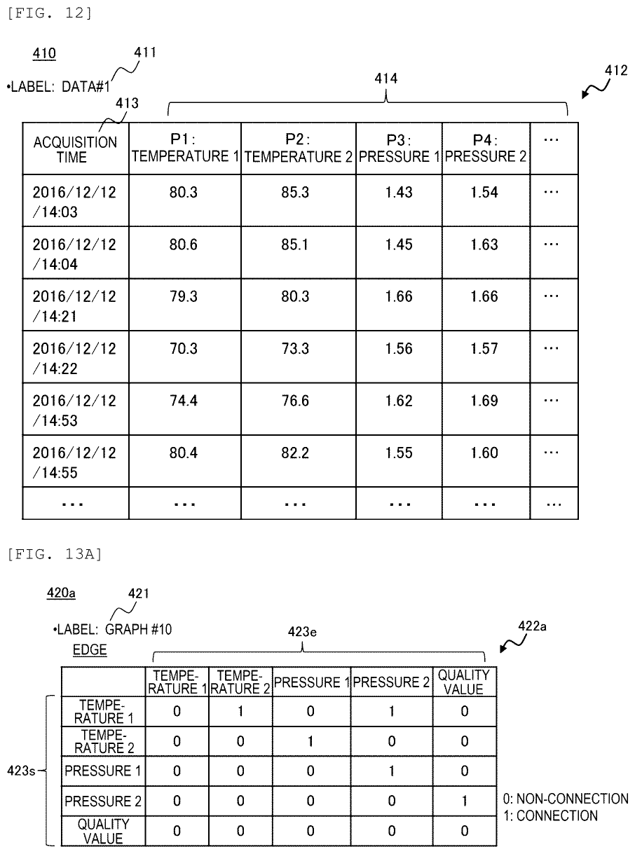

FIG. 12 is an example of target data associated with a node. FIG. 12 shows a data structure example of data stored in the data storage unit 41. The data is uploaded from a data upload screen (not shown) that is transitioned to by pressing an upload data button 216b on the graph description screen 210, and is saved in the data storage unit 41. Target data 410 includes a data ID 411 for identifying data and table data 412. In this example, the table data 412 has an acquisition time 413 and acquisition data 414, and values of data items acquired at a time indicated by the acquisition time 413 are stored in records of the acquisition data 414.

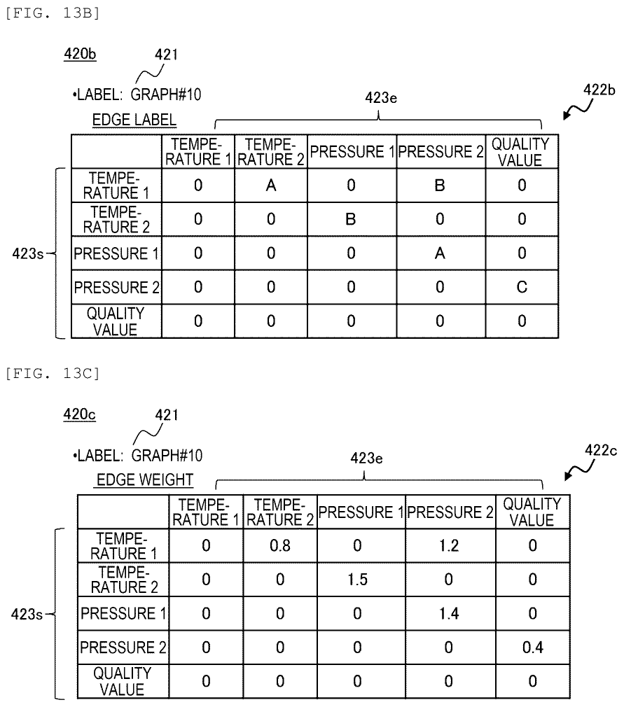

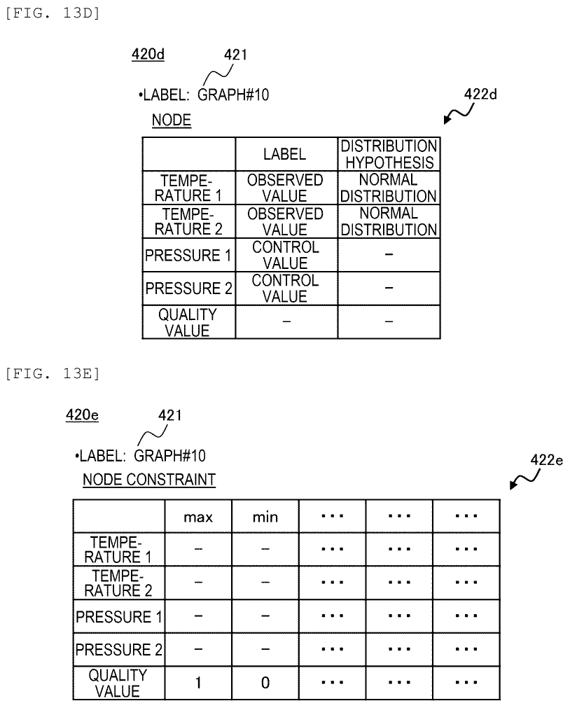

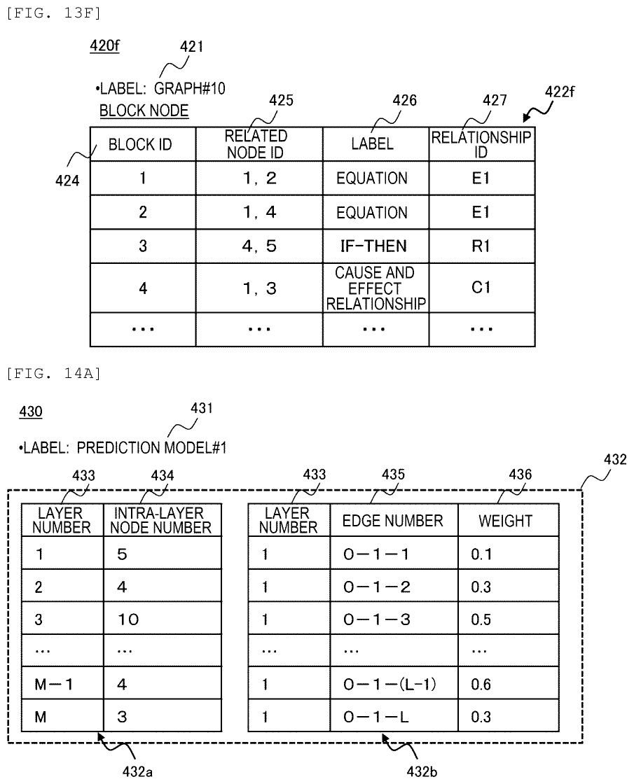

Examples of information based on knowledge of the user added to the graph will be described with reference to FIGS. 13A to 13F. FIGS. 13A to 13F are data structure examples of data stored in the graph storage unit 42 (see FIG. 1). Although details will be described later, the graph created in step S01 is transformed into data in a table format in step S02 to be described later, and is saved in the graph storage unit 42 of the storage unit 40. FIGS. 13A to 13F are graph data for saving definitions of nodes and edges in the same one graph, and each have a graph ID 421 for identifying a graph and table data 422a to 422f.

FIG. 13A shows edge data 420a. In the edge data 420a, presence or absence of an edge between a start point node 423s and an end point node 423e of an edge is registered. Registering 1 in a field that is an intersection of the start point node 423s and the end point node 423e indicates that there is an edge (connection), and registering 0 indicates that there is no edge (non-connection). The edge data 420a is an adjacency matrix in a graph theory.

FIG. 13B shows edge label data 420b. In the edge label data 420b, a label (attribute) of an edge defined between the start point node 423s and the end point node 423e of the edge is registered. The label can be defined by a character string or a numerical value.

FIG. 13C shows edge weight data 420c. In the edge weight data 420c, a weight of an edge between the start point node 423s and the end point node 423e of the edge is registered.

FIG. 13D shows node data 420d. Labels and distribution hypotheses of nodes in the graph are registered in the node data 420d. The label of the node includes, for example, an observed value obtained by observing a target system and a control value for controlling the target system. Further, when the label of the node is the observed value, probability distribution information (referred to as distribution hypothesis) estimated by the user based on an expected value is registered.

FIG. 13E shows node constraint data 420e. In the node constraint data 420e, a constraint condition regarding a value that a node can take is registered. Examples of the constraint condition include a maximum value and a minimum value.

FIG. 13F shows block node data 420f. The block node data 420f registers a relationship between nodes represented by a block node. A block ID 424 is an ID for identifying a block node. A related node ID 425 registers a combination of nodes indicating a relationship of block nodes with a node ID for identifying a node. In this example, the block node with a block ID 1 indicates that a relationship between a start point node with a node ID 1 and an end point node with a node ID 2 is registered.

In the present embodiment, a relationship between nodes is expressed in a format suitable for the relationship. A label 426 represents an expression format of the relationship. In this example, an expression format such as “equation”, “IF-THEN rule”, and “cause and effect relationship” is shown. In a relationship ID 427, a relationship ID for identifying a specific relational expression or rule is registered. In this example, a block node with block ID 1 indicates that a relationship is described using a specific equation defined in a relationship ID E1, and a block node with a block ID 3 indicates that a relationship is described using a specific IF-THEN rule defined in a relationship ID R1.

Thus, in step S01, a graph is created on the GUI screen, and information as shown in FIG. 12 and FIGS. 13A to 13F is added to the node and edge in the created graph. Therefore, domain knowledge is described as a definition of a node or an edge in the graph.

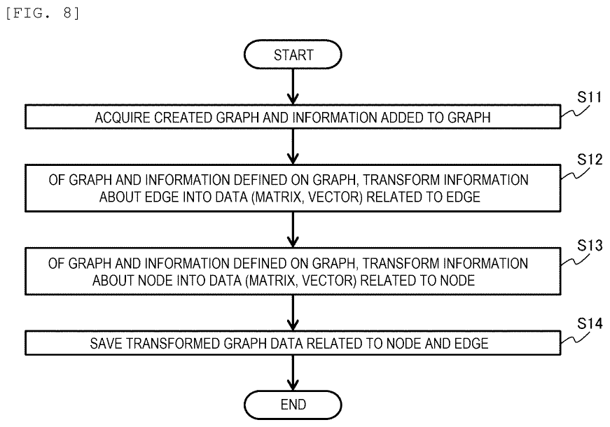

Step S02: Returning to description of a flowchart in FIG. 7. The graph transformation processing unit 32 transforms the graph (step S01) described by the graph description unit 31 into an adjacency matrix or vector. The graph saving unit 33 stores the transformed adjacency matrix and vector as graph data in the graph storage unit 42. When a transform button 216c on the graph description screen 210 is pressed, processing of step S02 is started. FIG. 8 shows a detailed processing flow of step S02.

Step S11: The graph transformation processing unit 32 acquires the graph 214 created in step S01 and information added to a node and an edge of the graph.

Step S12: Of the information acquired in step S11, information about an edge is transformed into graph data related to the edge. Presence or absence of an edge can be expressed as an adjacency matrix based on a structure of the graph (FIG. 13A). Label information and weight information added to the edge can be expressed as vectors of a start point node and an end point node of the edge (FIGS. 13B and 13C).

Step S13: Of the information acquired in step S11, information about a node, that is an observation variable, a control variable, or a disturbance and information about a block node that defines a relationship between nodes are transformed into graph data. Examples of the information added to the node include an observation variable and a control variable, upper and lower limit values of a disturbance, distribution hypothesis information, a data type, and any label information (FIGS. 13D and 13E). As the information added to the block node that defines a relationship between nodes, there may be a determination rule represented by IF-THEN, a mathematical equation, and any label information representing a relationship (FIG. 13F). The above is an example of information defined by the user, and the invention is not limited thereto.

Step S14: When the user presses a save button 216d on the graph description screen 210, the graph saving unit 33 saves the transformed graph data related to the node and the edge in the graph storage unit 42. The saved graph data is data shown in FIGS. 13A to 13F.

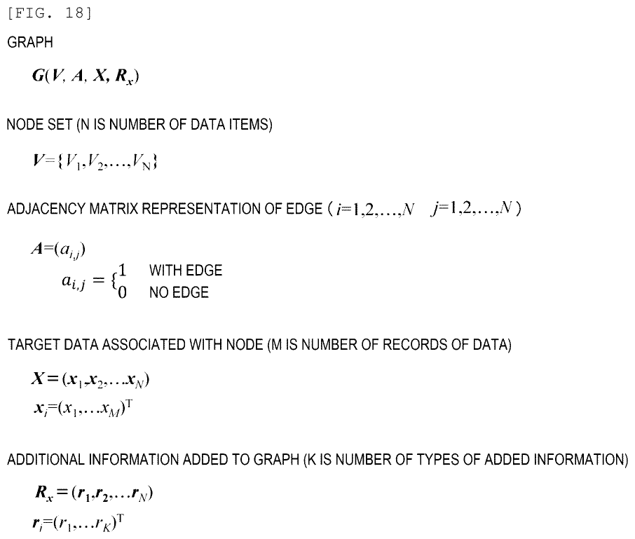

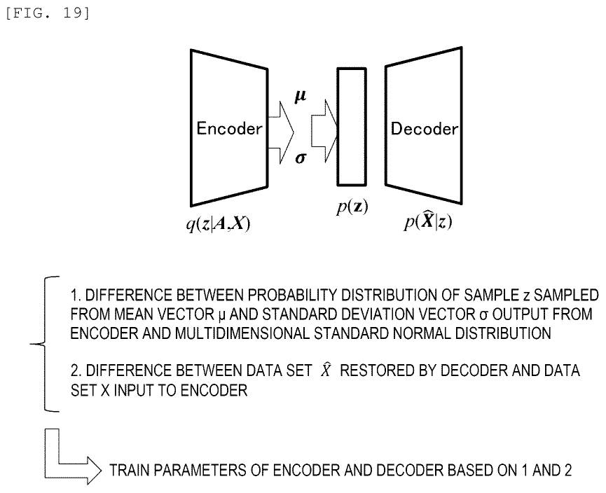

Thus, by transforming a graph that describes the domain knowledge into a matrix or a vector format, domain knowledge described as a graph can be handled by a mathematical model. FIG. 18 shows graph data when interpreted as a mathematical expression format. A graph G is expressed as a total of a node set V indicating a structure of the graph, an adjacency matrix representation A of the edge, target data X associated with the node, and additional information R added to the graph. Accordingly, domain knowledge can be handled in a mathematical model. Data corresponding to the graph G saved in step S02 will be collectively referred to as mathematical graph data below.

Step S03: Returning to the description of the flowchart in FIG. 7. In the present step, preprocessing of data used when constructing a prediction model is performed. The prediction model is a model for predicting a response variable based on an independent variable, and is trained by machine learning.

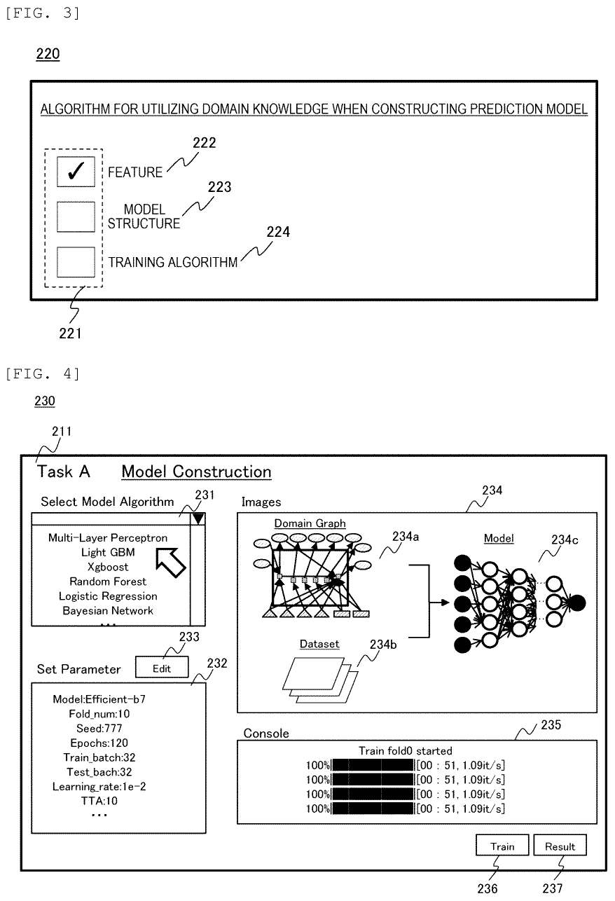

First, the user selects a utilization algorithm that utilizes domain knowledge when constructing a prediction model. When the user presses a select algorithm button 217 on the graph description screen 210, the algorithm selection unit 34 makes a transition from the graph description screen 210 to a GUI screen for selecting a utilization algorithm. FIG. 3 shows an algorithm selection screen 220 displayed by an algorithm selection screen display unit 22.

The algorithm selection screen 220 includes a list of utilization algorithms and a check box 221 for selecting a utilization algorithm. In this example, three utilization algorithms, a feature 222, a model structure 223, and a training algorithm 224, are displayed as methods of utilizing a graph including domain knowledge in a machine learning model. By clicking the check box 221, the box is checked, and a corresponding utilization algorithm is selected.

The three utilization algorithms are different from each other in a method of reflecting the domain knowledge when the prediction model is constructed. The feature 222 is a utilization method of reflecting domain knowledge by creating input data (feature) from mathematical graph data to a prediction model. The model structure 223 is a utilization method that reflects a structure of the graph indicated by graph data, that is, a relationship between the nodes, in a structure of the prediction model, that is, in a relationship between independent variables. The training algorithm 224 is a utilization method that reflects additional information on mathematical graph data, such as information on a relationship between nodes defined as a block node, in a constraint condition and a convergence condition (collectively referred to as a training condition) for training of the prediction model. It is not necessary that all the three shown utilization algorithms can be selected, and it is sufficient that at least one of the three utilization algorithms can be selected.

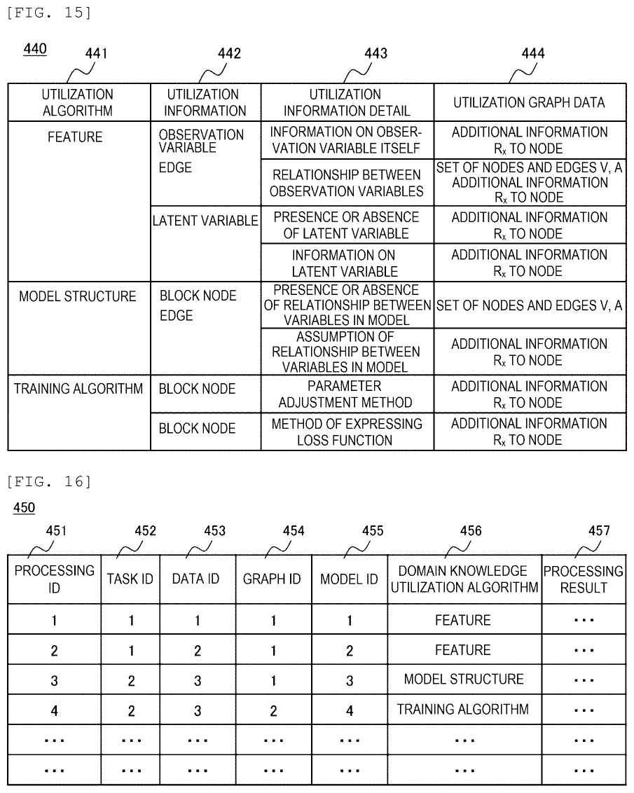

FIG. 15 shows a data structure example of algorithm data 440 stored in the algorithm storage unit 44 (see FIG. 1). Each utilization algorithm 441 includes utilization information 442 indicating contents of graph data to be utilized, utilization information detail 443 as details thereof, and utilization graph data 444 for specifying graph data to be utilized specifically. The utilization algorithm 441 corresponds to a list displayed on the algorithm selection screen 220 (see FIG. 3). The utilization information 442 includes a latent variable extracted from mathematical graph data in addition to parts displayed on the palette 213 (see FIG. 2) of the graph description screen 210. Examples of the latent variable will be described later. Although the utilization graph data 444 is described as a format in FIG. 15, contents of necessary additional information and the like are specifically specified.

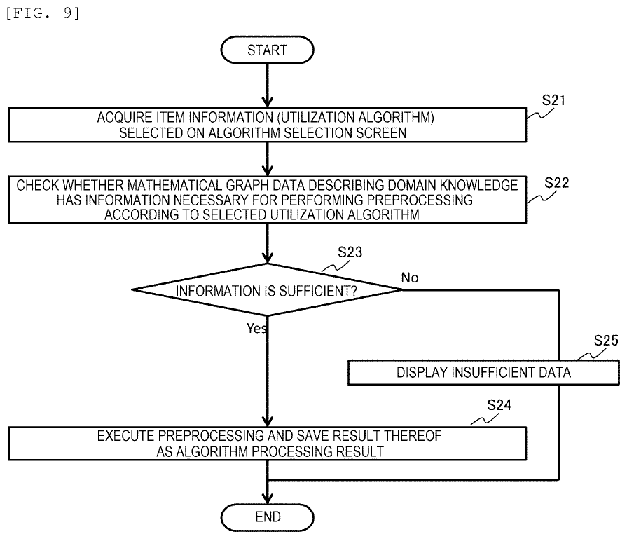

In order to utilize the domain knowledge thus, since it is necessary that necessary data corresponding to the utilization algorithm is available in the mathematical graph data, the algorithm processing unit 35 checks whether mathematical graph data corresponding to the utilization algorithm selected on the algorithm selection screen 220 is available, and then performs preprocessing of the mathematical graph data according to the utilization algorithm. FIG. 9 shows a detailed processing flow of the algorithm processing unit 35.

Step S21: Item information (utilization (algorithm) selected on the algorithm selection screen 220 is acquired.

Step S22: The algorithm processing unit 35 checks whether mathematical graph data showing the domain knowledge has information necessary for performing processing corresponding to the selected utilization algorithm. Since the information necessary for the utilization algorithm is stored in the algorithm storage unit 44 shown in FIG. 15, it is only necessary to compare the mathematical graph data with the utilization information 442 and the utilization graph data 444 for each utilization algorithm registered in the algorithm storage unit 44.

If it is determined that the information is sufficient (Yes in step S23), preprocessing according to the selected utilization algorithm is executed, and the algorithm processing result saving unit 36 saves a processing result in the algorithm processing storage unit 45 (step S24). On the other hand, if the information is not sufficient (No in Step S23), for example, if the information necessary for the utilization algorithm is incomplete or not present, insufficient data is displayed to the user, and the user is asked to replenish the information (Step S25).

FIG. 10 shows details of a processing flow of step S24 executed by the algorithm processing unit 35 when the “feature” is selected as the utilization algorithm. An example in FIG. 10 is an example of creating a generative model for extracting a latent variable in order to extract a latent variable as the feature. Unlike the observation variable, the latent variable is not a variable actually observed, but is a variable estimated from other observed variables. Since the latent variable can represent high-dimensional data with a lower-dimensional variable, the latent variable can be regarded as a variable that represents characteristics of a graph that describes the domain knowledge. Therefore, by using the latent variable extracted from the data selected by the user based on the domain knowledge as input data for the prediction model, the domain knowledge can be reflected in the prediction model.

Here, a method of using a variation autoencoder as the generative model will be described as an example. FIG. 19 shows a generative model using the variation autoencoder. The generative model using the variation autoencoder includes an encoder and a decoder, and has a structure in which information X input by the encoder is expressed by a low-dimensional latent space Z, and data z on the expressed latent space is expressed in a dimension of the original data X by the decoder. The encoder learns so that a data distribution p(z) becomes continuous (multidimensional standard normal distribution) on the latent space. The decoder calculates a weight on the structure such that the data obtained by decoding the data z on the latent space is close to the original data. The model and a training method are merely examples and are not limited thereto.

Step S31: A generative model is created having the number of data items of the target data X associated with a node as the number of inputs from the mathematical graph data.

Step S32: The generative model is trained. The training method in the generative model using the variation autoencoder is as shown in FIG. 19.

Thereafter, the trained generative model is saved in the algorithm processing storage unit 45 as an algorithm processing result (step S33), and an end of the training is output on a screen (step S34).

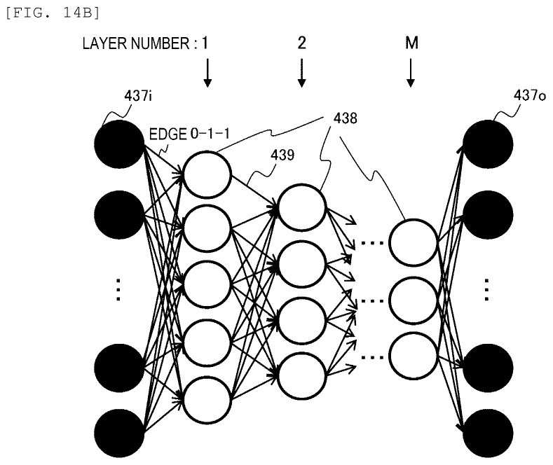

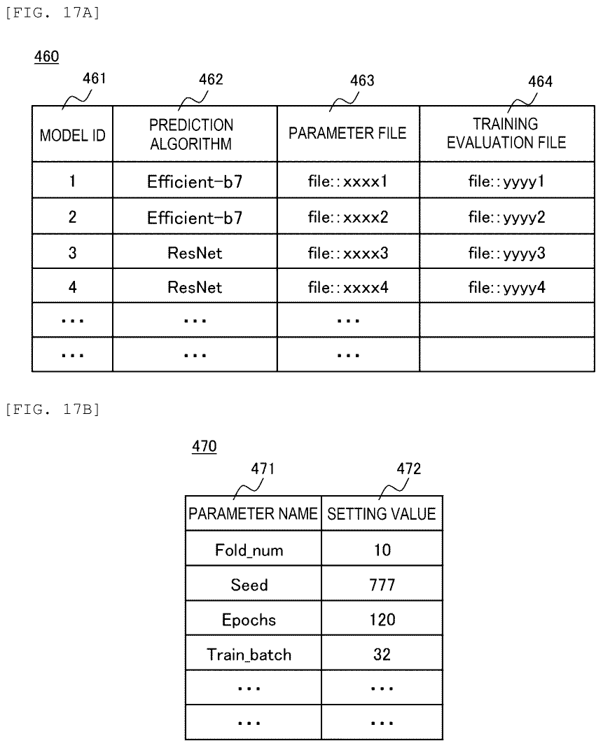

FIG. 16 shows a data structure example of management data 450 for managing a preprocessing result stored in the algorithm processing storage unit 45 by the algorithm processing result saving unit 36. A process ID 451 is an ID uniquely indicating processing when a corresponding task ID, data ID, graph ID, and model ID are used. A task ID 452 corresponds to the task ID 211 in FIG. 2, a data ID 453 corresponds to the data ID 411 in FIG. 12, a graph ID 454 corresponds to the graph ID 421 in FIGS. 13A to 13F, and the model ID corresponds to a model ID 431 in FIG. 14A to be described later. The utilization algorithm selected on the algorithm selection screen 220 is registered in the domain knowledge utilization algorithm 456. A processing result 457 shows an address and a data path in which a result of preprocessing according to the utilization algorithm (for example, the generative model created in the processing flow in FIG. 10) is saved. Accordingly, it is possible to grasp how domain knowledge described as mathematical graph data is used.

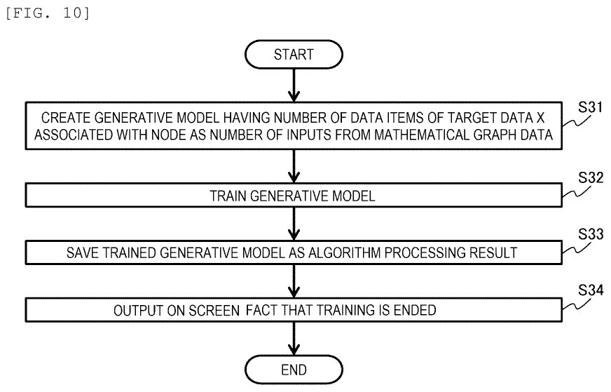

Step S04: Returning to the description of the flowchart in FIG. 7. In the present step, the prediction model is constructed and evaluated using graph data and preprocessed data created in step S03. As an example of construction and evaluation of the prediction model, FIG. 11 shows a detailed processing flow when the “feature” algorithm is selected.

Step S41: Mathematical graph data is acquired from the data storage unit 41 and the graph storage unit 42.

Step S42: A generative model is acquired from the algorithm processing storage unit 45, and a latent variable is acquired from the generative model and the mathematical graph data.

Step S43: The user constructs a prediction model on a prediction model construction screen. FIG. 4 shows a model construction screen 230 displayed by a model construction screen display unit 23. The model construction screen 230 is a screen for constructing a prediction model for a target object and performing training. The model construction screen 230 includes a selection screen 231 that is managed by the task ID 211 and for selecting a prediction algorithm to be used for constructing a prediction model, a parameter setting screen 232 and a parameter setting change button 233 for setting a training parameter of the prediction model, a prediction model display screen 234 that represents a graph showing domain knowledge, data and an overview of the prediction model, a training status display screen 235 that displays a training status of the prediction model, a training start button 236, and a training result display button 237.

Prediction algorithms set in advance are displayed on the selection screen 231, and the user selects a prediction algorithm used for construction. A value of the parameter setting screen 232 can be changed by pressing the parameter setting change button 233, so that it is possible to change setting values of training parameters. An item of the set training parameter varies depending on the prediction algorithm to be used, and is updated each time. When the selected utilization algorithm is the training algorithm, a definition of the node in the graph showing the domain knowledge is reflected in the setting value of the training parameter.

A graph 234a, data 234b, and a prediction model structure 234c showing domain knowledge are displayed on the prediction model display screen 234. In the graph 234a, for example, a graph created by the campus 212 on the graph description screen 210 is displayed. As the data 234b, data uploaded by the user on the graph description screen 210 is displayed in a table or a summary form. For the prediction model structure 234c, an outline diagram of a prediction model based on a prediction algorithm selected on the selection screen 231 is displayed. When the selected utilization algorithm has a model structure, a structure of the graph showing the domain knowledge is reflected in a structure of the prediction model.

The model construction unit 37 constructs a prediction model using mathematical graph data based on the prediction algorithm selected on the model construction screen 230. Although input data including target data associated with the graph is input to the prediction model, when the feature is selected as the utilization algorithm, the latent variable derived from the mathematical graph data is also used as an input to the prediction model. In the example shown in FIG. 19, a prediction model is constructed in which the original data X and the data z on the latent space are input as explanatory variables, and prediction data y as a response variable is output.

FIG. 14A shows a data structure example of prediction model data 430 stored in the model storage unit 43. FIG. 14B shows a corresponding schematic diagram. Here, an example in which the prediction model is a neural network is shown.

In the schematic diagram (FIG. 14B), nodes that are present in an input layer 437i and an output layer 437o of a model represented by the neural network are represented by black circles, and the nodes of an intermediate layer 438 are represented by white circles. A layer number represents an order of an intermediate layer, and a layer number of an intermediate layer closest to the input layer is 1. In this example, the intermediate layer has a first layer to an M-th layer. An edge 439 is provided between a node of the input layer and a node of the intermediate layer first layer, between nodes of the adjacent intermediate layers, between a node of the intermediate layer M-th layer and a node of the output layer. A weight is set for each edge 439.

A structure of a prediction model as shown in FIG. 14B is stored in the model storage unit 43 as data in a table format in FIG. 14A. The model ID 431 is an ID for identifying the prediction model. Table data 432 includes node table data 432a for registering node information and edge table data 432b for registering edge information.

The node table data 432a includes a layer number 433 and an intra-layer node number 434. The number of nodes in a layer designated by the layer number 433 is registered in the intra-layer node number 434. The edge table data 432b includes the layer number 433, an edge number 435, and a weight 436. An edge number, which specifies an edge whose end point node is a node in a layer designated by the layer number 433, is registered in the edge number 435. A weight of the edge designated by the edge number 435 is registered in the weight 436.

Step S44: The model evaluation unit 38 evaluates the prediction model being trained by the model construction unit 37. When a training parameter of the prediction model is set on the model construction screen 230 (see FIG. 4) and the training start button 236 is pressed, the model construction unit 37 starts training the prediction model. For example, if the prediction model is a prediction model in which the original data X and the data z on the latent space are input and the prediction data y is output, a parameter of the prediction model, for example, a weight of an edge shown in FIG. 14B is adjusted so that training data y′ and the prediction data y become equal. When the model evaluation unit 38 obtains an evaluation that the prediction data y of the prediction model outputs a sufficiently approximate value to the training data y′, the model construction unit 37 ends training of the prediction model. A training progress status of the prediction model i displayed on the training status display screen 235 of the model construction screen 230. For example, a training time and a progress status thereof in a training step of the prediction model are displayed.

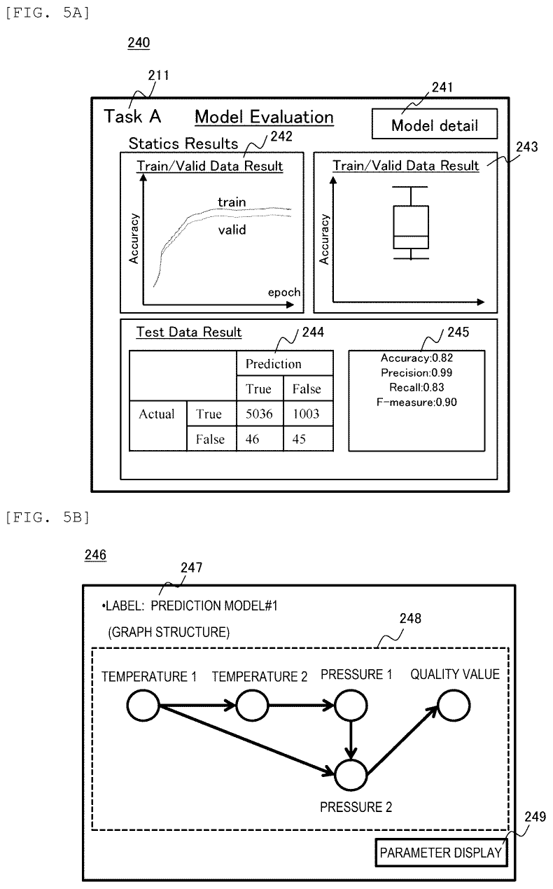

Step S45: The model evaluation unit 38 outputs on the GUI screen the fact that training of the prediction model is ended. When this display is received and the user presses the training result display button 237 on the model construction screen 230 (see FIG. 4), the GUI screen transitions to a model result display screen 240 shown in FIG. 5A.

The model result display screen 240 displayed by a model result display screen display unit 24 displays a result of training the prediction model for the target object constructed on the model construction screen 230 under a set training condition. The model result display screen 240 is managed by the task ID 211, and displays prediction accuracy of the prediction model at the time of training and verification with a polygonal line graph 242, a box plot 243, a mixing matrix 244, a text 245, and the like.

When a model detail display button 241 is pressed, the model result display screen 240 transitions to a model detail display screen 246 shown in FIG. 5B. On the model detail display screen 246, detailed information on the prediction model is displayed, and the user can grasp contents of the prediction model.

The model detail display screen 246 includes a model ID 247 for identifying a prediction model, a display screen 248 for displaying a graph showing domain knowledge used by the prediction model, and a parameter display button 249 for transitioning to a screen for displaying a parameter and the like related to the prediction model. The display screen 248 displays a graph transformed when using the graph created on the graph description screen 210 with a machine learning model. When the parameter display button 249 is pressed, the display screen 248 transitions to a screen for displaying a model algorithm, a parameter, and the like used when the prediction model is constructed.

Step S05: Returning to the description of the flowchart in FIG. 7. In the present step, the model processing result saving unit 39 (see FIG. 1) saves the prediction model constructed in step S04, the data (training parameter or the like) used when the prediction model is constructed, and training evaluation result data of the prediction model. The parameter used for training the prediction model and a training evaluation result are stored in the model processing result storage unit 46.

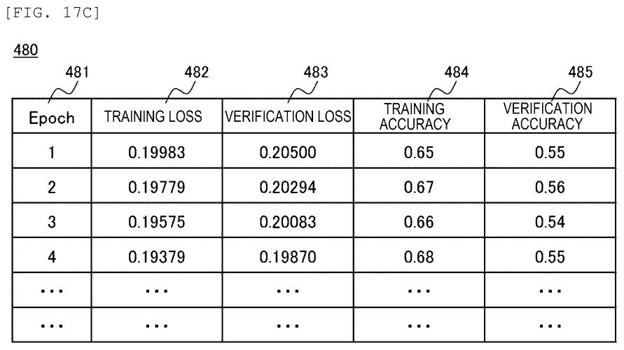

FIGS. 17A to 17C show data structure examples of management data 460 for managing a result of training and evaluating the prediction model, which is stored in the model processing result storage unit 46. The management data 460 manages a trained and evaluated prediction model. A model ID shown in FIG. 14A and the like are registered in a model ID 461, and a prediction algorithm 462, a parameter file 463, and a training evaluation file 464 for the prediction model designated by the model ID 461 are registered. A prediction algorithm name selected when constructing the prediction model is registered in the prediction algorithm 462. A link to a training parameter file set when constructing the prediction model is registered in the parameter file 463. A link to a training result file when training and evaluating of the prediction model are performed is registered in the training evaluation file 464.

FIG. 17B shows a data structure example of a parameter file. A parameter file 470 includes a parameter name 471 and a setting value 472 for registering a setting value for a parameter designated by the parameter name 471.

FIG. 17C shows a data structure example of the training evaluation file. In a training evaluation file 480, a training loss 482, a verification loss 483, training accuracy 484, and verification accuracy 485 in an epoch 481 and an epoch designated by the epoch 481 are registered. In general, in machine learning, training data is repeatedly trained to prediction data, an epoch refers to a stage in which training is completed once for all the training data, and the number of repetitions is referred to as an epoch number. Based on the training evaluation file 480, evaluation information on prediction accuracy of the trained prediction model is displayed on the model result display screen 240 shown in FIG. 5A.

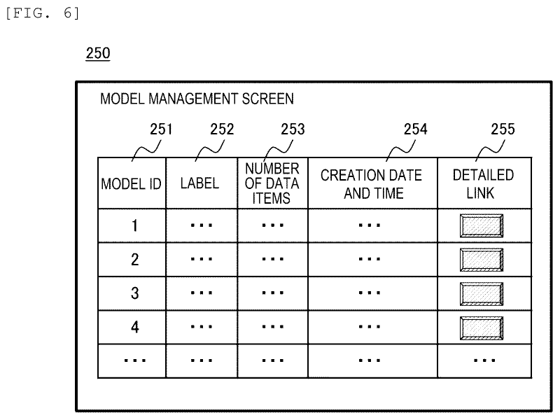

A model management screen display unit 25 is created according to the flow in FIG. 7, and displays a management screen for managing the prediction model accumulated in the domain knowledge utilization system 1. A model management screen 250 shown in FIG. 6 displays information on a prediction model that is trained and evaluated as a record. The model management screen 250 displays information on the prediction model that is trained and evaluated in a table format. Specifically, the model management screen 250 includes a model ID 251 for identifying a prediction model, a label 252 indicating contents of the prediction model, the number of data items 253 indicating the number of data items of upload data used by the prediction model, a creation date and time 254 indicating a date and time of performing construction, training, and evaluation of the prediction model, and a detailed link 255 displaying a transition button for a transition to the model detail display screen 246 (see FIG. 5B) indicating details of the prediction model. By pressing the transition button of the detailed link 255, the model detail display screen 246 corresponding to the prediction model is displayed.

Although the invention has been specifically described based on the embodiment of the invention made by the present inventors, the invention is not limited to the embodiment, and it is needless to say that various modifications can be made without departing from the gist of the invention.

### REFERENCE SIGNS LIST

1: domain knowledge utilization system
11: input and output unit
12: communication unit
20: display unit
21: graph description screen display unit
22: algorithm selection screen display unit
23: model construction screen display unit
24: model result display screen display unit
25: model management screen display unit
30: control unit
31: graph description unit
32: graph transformation processing unit
33: graph saving unit
34: algorithm selection unit
35: algorithm processing unit
36: algorithm processing result saving unit
37: model construction unit
38: model evaluation unit
39: model processing result saving unit
40: storage unit
41: data storage unit
42: graph storage unit
43: model storage unit
44: algorithm storage unit
45: algorithm processing storage unit
46: model processing result storage unit
210: graph description screen
211: task ID
212: campus
213: palette
213a: system box
213b: observation variable node
213c: control variable node
213d: disturbance node
213e: block node
213f: edge
214: graph
215: icon
216a: upload graph button
216b: upload data button
216c: transform button
216d: save button
217: select algorithm button
220: algorithm selection screen
221: check box
222: feature
223: model structure
224: training algorithm
230: model construction screen
231: selection screen
232: parameter setting screen
233: parameter setting change button
234: prediction model display screen
234a: graph
234b: data
234c: prediction model structure
235: training status display screen
236: training start button
237: training result display button
240: model result display screen
241: model detail display button
242: polygonal line graph
243: box plot
244: mixing matrix
245: text
246: model detail display screen
247: model ID
248: display screen
249: parameter display button
250: model management screen
251: model ID
252: label
253: number of data items
254: creation date and time
255: detailed link
410: target data
411: data ID
412: table data
413: acquisition time
414: acquisition data
420a: edge data
420b: edge label data
420c: edge weight data
420d: node data
420e: node constraint data
420f: block node data
421: graph ID
422a to 422f: table data
423s: start point node
423e: end point node
424: block ID
425: related node ID
426: label
427: relationship ID
430: prediction model data
431: model ID
432: table data
432a: node table data
432b: edge table data
433: layer number
434: intra-layer node number
435: edge number
436: weight
437i: input layer
437o: output layer
438: intermediate layer
439: edge
440: algorithm data
441: utilization algorithm
442: utilization information
443: utilization information detail
444: utilization graph data
450: management data
451: processing ID
452: task ID
453: data ID
454: graph ID
455: model ID
456: domain knowledge utilization algorithm
457: processing result
460: management data
461: model ID
462: prediction algorithm
463: parameter file
464: training evaluation file
470: parameter file
471: parameter name
472: setting value
480: training evaluation file
481: epoch
482: training loss
483: verification loss
484: training accuracy
485: verification accuracy

1. A domain knowledge utilization system comprising:
a graph description unit configured to describe domain knowledge about a target system as a definition of a node or an edge in a graph including nodes and edges indicating a relationship between nodes;
a model construction unit configured to perform construction and training of a prediction model for predicting a response variable based on an explanatory variable for the target system; and
an algorithm selection unit configured to select a utilization algorithm for utilizing domain knowledge described by the graph for construction and training of the prediction model, wherein
a utilization algorithm that is selectable by the algorithm selection unit includes at least one or more of a first utilization algorithm using a feature derived from the graph as an explanatory variable of the prediction model, a second utilization algorithm applying a relationship between nodes in the graph to a relationship between explanatory variables of the prediction model, and a third utilization algorithm applying a definition of a node in the graph to a training condition of the prediction model.

2. The domain knowledge utilization system according to claim 1, further comprising:
a graph storage unit configured to store a definition of a node and an edge in the graph described by the graph description unit as graph data; and
a data storage unit configured to store data of the target system associated with a node in the graph as target data, wherein
a data item of the target data is included as an explanatory variable of the prediction model.

3. The domain knowledge utilization system according to claim 2, further comprising:
an algorithm processing unit configured to perform, according to a utilization algorithm selected by the algorithm selection unit, preprocessing of the graph data stored in the graph storage unit and/or the target data stored in the data storage unit, wherein
when the first utilization algorithm is selected by the algorithm selection unit, the algorithm processing unit extracts a latent variable of the graph as the feature using the graph data and the target data.

4. The domain knowledge utilization system according to claim 1, wherein
a node in the graph includes an observation variable node representing a data item observable from the target system, a control variable node representing a data item used as a control item in the target system, a disturbance node representing a disturbance of the target system, and a block node representing a relationship between nodes in the target system.

5. A domain knowledge utilization method comprising:
a first step of showing domain knowledge about a target system as a definition of a node or an edge in a graph including nodes and edges indicating a relationship between nodes;
a second step of performing construction and training of a prediction model for predicting a response variable based on an explanatory variable for the target system; and
a third step of selecting a utilization algorithm for utilizing domain knowledge described by the graph for construction and training of the prediction model, wherein
a utilization algorithm that is selectable in the third step includes at least one or more of a first utilization algorithm using a feature derived from the graph as an explanatory variable of the prediction model, a second utilization algorithm applying a relationship between nodes in the graph to a relationship between explanatory variables of the prediction model, and a third utilization algorithm applying a definition of a node in the graph to a training condition of the prediction model.

6. The domain knowledge utilization method according to claim 5, wherein
a definition of a node and an edge in the graph described by the first step is stored as graph data,
data of the target system associated with a node in the graph is stored as target data, and
a data item of the target data is included as an explanatory variable of the prediction model.

7. The domain knowledge utilization method according to claim 6, further comprising:
a fourth step of performing preprocessing of the graph data and/or the target data according to a utilization algorithm selected in the third step, wherein
when the first utilization algorithm is selected in the third step, in the fourth step, a latent variable of the graph is extracted as the feature using the graph data and the target data.

8. The domain knowledge utilization method according to claim 5, wherein
a node in the graph includes an observation variable node representing a data item observable from the target system, a control variable node representing a data item used as a control item in the target system, a disturbance node representing a disturbance of the target system, and a block node representing a relationship between nodes in the target system.

9. A domain knowledge utilization program causing a computer to execute
a first procedure of showing domain knowledge about a target system as a definition of a node or an edge in a graph including nodes and edges indicating a relationship between nodes;
a second procedure of performing construction and training of a prediction model for predicting a response variable based on an explanatory variable for the target system; and
a third procedure of selecting a utilization algorithm for utilizing domain knowledge described by the graph for construction and training of the prediction model, wherein
a utilization algorithm that is selectable in the third procedure includes at least one or more of a first utilization algorithm using a feature derived from the graph as an explanatory variable of the prediction model, a second utilization algorithm applying a relationship between nodes in the graph to a relationship between explanatory variables of the prediction model, and a third utilization algorithm applying a definition of a node in the graph to a training condition of the prediction model.

10. The domain knowledge utilization program according to claim 9, wherein
a definition of a node and an edge in the graph described by the first procedure is stored as graph data,
data of the target system associated with a node in the graph is stored as target data, and
a data item of the target data is included as an explanatory variable of the prediction model.

11. The domain knowledge utilization program according to claim 10 further causing a computer to execute
a fourth procedure of performing preprocessing of the graph data and/or the target data according to a utilization algorithm selected in the third procedure, wherein
when the first utilization algorithm is selected in the third procedure, in the fourth procedure, a latent variable of the graph is extracted as the feature using the graph data and the target data.

12. The domain knowledge utilization program according to claim 9, wherein
a node in the graph includes an observation variable node representing a data item observable from the target system, a control variable node representing a data item used as a control item in the target system, a disturbance node representing a disturbance of the target system, and a block node representing a relationship between nodes in the target system.
